(19) United States
(12) Patent Application Publication
(10) Pub. No.: US 2021/0213743 A1
(43) Pub. Date: Jul. 15, 2021

(54) LIQUID EJECTION APPARATUS AND METHOD FOR DETACHING WASTE LIQUID CONTAINER

(71) Applicant: Canon Kabushiki Kaisha, Tokyo (JP)

(72) Inventors: Takashi Sugawara, Kanagawa (JP); Kenji Tamamori, Kanagawa (JP); Keiji Watanabe, Kanagawa (JP)

(21) Appl. No.: 17/148,967

(22) Filed: Jan. 14, 2021

(30) Foreign Application Priority Data
Jan. 15, 2020 (JP) 2020-004209

(51) Int. Cl. B41J 2/17; B41J 2/165

(52) U.S. Cl. CPC B41J 2/1721; B41J 2002/1742; B41J 2/16523

(57) ABSTRACT

Provided is a liquid ejection apparatus capable of suppressing user's hands, and the like from being contaminated with the waste liquid attached to the waste liquid holding portion when the waste liquid container is detached. A liquid ejection apparatus includes a liquid ejection head that ejects a liquid; a waste liquid holding portion that is provided around the discharge portion that discharges a waste liquid; and a mounting portion on which the waste liquid container that is capable of containing the waste liquid is mounted, in which the waste liquid container is detachable from the mounting portion, the waste liquid container has a wiping portion that moves while being in contact with the waste liquid holding portion, and at least a part of the wiping portion is located on a rear side of the discharge portion in a direction in which the waste liquid container is detached.

### BACKGROUND OF THE INVENTION

### Field of the Invention

The present invention relates to a liquid ejection apparatus and a method for detaching a waste liquid container.

### Description of the Related Art

An ink jet recording apparatus, which is an example of a liquid ejection apparatus, ejects a liquid ink from a liquid ejection head toward a recording medium to perform recording, and also discharges the liquid ink from the liquid ejection head not for recording but for maintenance or the like in some cases. Japanese Patent Application Laid-Open No. 2019-18405 discloses a waste liquid container for storing a waste liquid discharged from the liquid ejection head. A mounting portion on which the waste liquid container is mounted is provided with a discharge portion that discharges the waste liquid discharged from the liquid ejection head toward the waste liquid container. A waste liquid holding portion that is capable of holding the waste liquid is provided around the discharge portion in order to suppress the waste liquid discharged from the discharge portion from dripping around the discharge portion and contaminating the inside of a housing of the liquid ejection apparatus.

In a liquid injection apparatus disclosed in Japanese Patent Application Laid-Open No. 2019-18405, when the waste liquid container is detached, the waste liquid holding portion around the discharge portion is exposed, so that the waste liquid attached to the waste liquid holding portion may contaminate the user's hands and clothes.

### SUMMARY OF THE INVENTION

According to the present invention, there is provided a liquid ejection apparatus including: a liquid ejection head that ejects a liquid; a discharge portion that discharges a waste liquid from the liquid ejection head; a waste liquid holding portion that is provided around the discharge portion; a waste liquid container that is capable of containing the waste liquid; and a mounting portion on which the discharge portion and the waste liquid holding portion are provided and the waste liquid container is mounted,

in which the waste liquid container is detachable from the mounting portion,

the waste liquid container has a wiping portion that moves while being in contact with the waste liquid holding portion in accordance with a detaching operation from the mounting portion, and

at least a part of the wiping portion is located on a rear side of the discharge portion in a direction in which the waste liquid container is detached.

Further features of the present invention will become apparent from the following description of exemplary embodiments with reference to the attached drawings.

### BRIEF DESCRIPTION OF THE DRAWINGS

FIG. 1 is a perspective view of a liquid ejection apparatus according to a first embodiment of the present invention.

FIG. 2 is a side view schematically illustrating a maintenance unit of the liquid ejection apparatus as illustrated in FIG. 1.

FIG. 3 is a partial perspective view of a state in which a waste liquid container is removed from a mounting portion of the liquid ejection apparatus illustrated in FIG. 1 as viewed from below.

FIG. 4 is a perspective view of the liquid ejection apparatus in the state illustrated in FIG. 3 as viewed from above.

FIG. 5 is a perspective view of the waste liquid container of the liquid ejection apparatus illustrated in FIG. 4.

FIG. 6 is a partial cross-sectional view schematically illustrating a state in which the waste liquid container illustrated in FIG. 5 is mounted on the mounting portion.

FIG. 7 is a partial perspective view of a periphery of a discharge portion and a waste liquid holding portion in the middle of attaching and detaching operation with respect to the mounting portion of the waste liquid container illustrated in FIG. 5 as viewed from below.

FIG. 8 is a partial cross-sectional view schematically illustrating a state in which the waste liquid container of the liquid ejection apparatus of a modification of the first embodiment of the present invention is mounted on the mounting portion.

FIG. 9A is a partial cross-sectional view schematically illustrating a state in which the waste liquid container of the liquid ejection apparatus of another modification of the first embodiment of the present invention is mounted on the mounting portion.

FIG. 9B is a partial cross-sectional view schematically illustrating a state in which the waste liquid container of the liquid ejection apparatus of another modification of the first embodiment of the present invention is mounted on the mounting portion.

FIG. 10A is a perspective view of a waste liquid container of still another modification of the first embodiment of the present invention.

FIG. 10B is a partial cross-sectional view schematically illustrating a state in which the waste liquid container of still another modification of the first embodiment of the present invention is mounted on the mounting portion.

FIG. 11A is a perspective view of a waste liquid container of still another modification of the first embodiment of the present invention.

FIG. 11B is an enlarged plan view of a wiping portion of the waste liquid container of still another modification of the first embodiment of the present invention.

FIG. 12A is a perspective view of a waste liquid container of the liquid ejection apparatus according to a second embodiment of the present invention.

FIG. 12B is an enlarged bottom view of the periphery of the discharge portion, the waste liquid holding portion, and the wiping portion of the liquid ejection apparatus according to the second embodiment of the present invention as viewed from below.

FIG. 12C is a partial cross-sectional view schematically illustrating a state in which the waste liquid container of the liquid ejection apparatus according to the second embodiment of the present invention is mounted on the mounting portion.

FIG. 13 is an enlarged bottom view of the periphery of the discharge portion, the waste liquid holding portion, and the wiping portion of a modification of the second embodiment of the present invention as viewed from below.

### DESCRIPTION OF THE EMBODIMENTS

An object of the present invention is to provide a liquid ejection apparatus capable of suppressing user's hands, clothes, and the like from being contaminated with the waste liquid attached to the waste liquid holding portion when the waste liquid container is detached, and a method for detaching the waste liquid container.

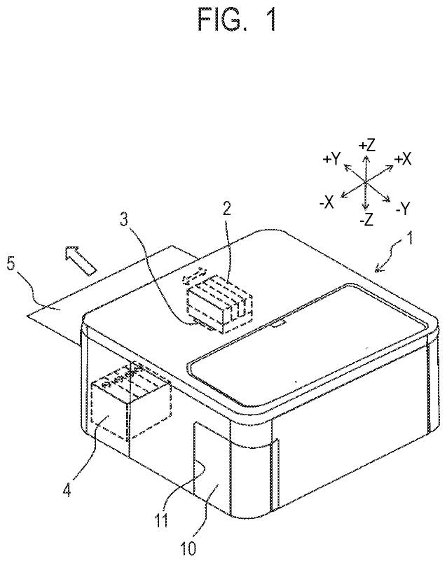

Hereinafter, preferable embodiments of the liquid ejection apparatus according to the present invention will be described with reference to the drawings. In the following description, an X direction, a Y direction, and a Z direction are defined as follows. The X direction is a main scanning direction of a carriage 2 on which a liquid ejection head 3 is mounted, and corresponds to a width direction of a liquid ejection apparatus 1. A side where a liquid tank 4 and a waste liquid container 10 of the liquid ejection apparatus 1 are located (left side in FIG. 1) is in a −X direction, and an opposite side is in a +X direction. The Y direction is a direction in which a recording medium 5 is discharged from the liquid ejection apparatus 1, and corresponds to a depth direction of the liquid ejection apparatus 1. An upstream side in the direction in which the recording medium 5 is discharged is in a −Y direction, and a downstream side is in a +Y direction. The Z direction is a vertical direction, which corresponds to a height direction of the liquid ejection apparatus 1. The vertical lower direction in a state in which the liquid ejection apparatus 1 is installed is in a −Z direction, and a vertical upper direction is in a +Z direction.

### First Embodiment

FIG. 1 is a perspective view of the liquid ejection apparatus 1 according to a first embodiment of the present invention. The liquid ejection apparatus 1 of the present embodiment is an ink jet printer including a liquid ejection head 3 mounted on a carriage 2 and a liquid tank 4 for storing a liquid ejected from the liquid ejection head 3. The liquid ejection head 3 mounted on the carriage 2 and reciprocating in the main scanning direction (X direction) discharges the liquid toward the recording medium 5 to perform recording. The liquid ejected from the liquid ejection head 3 is supplied from the liquid tank 4 to the liquid ejection head 3 via a flexible liquid supply tube (not shown), a tube connection portion, and a liquid supply path.

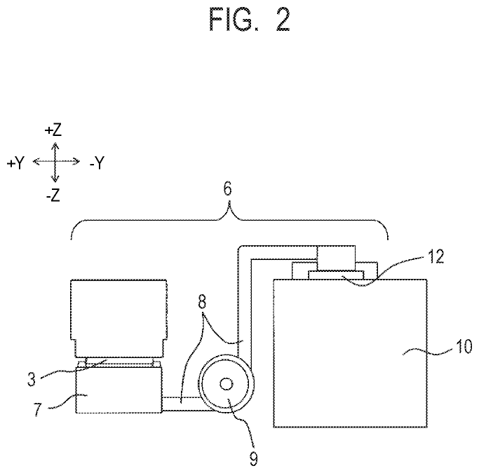

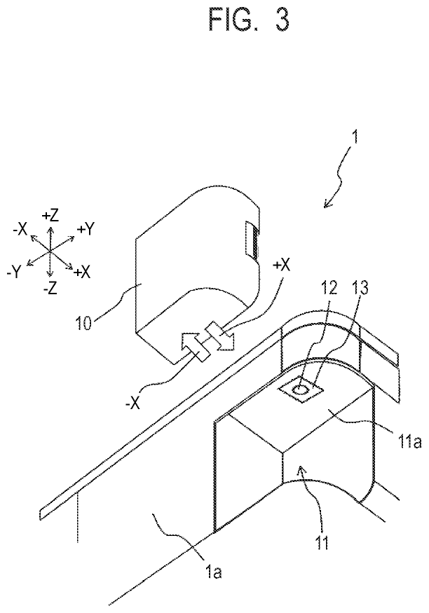

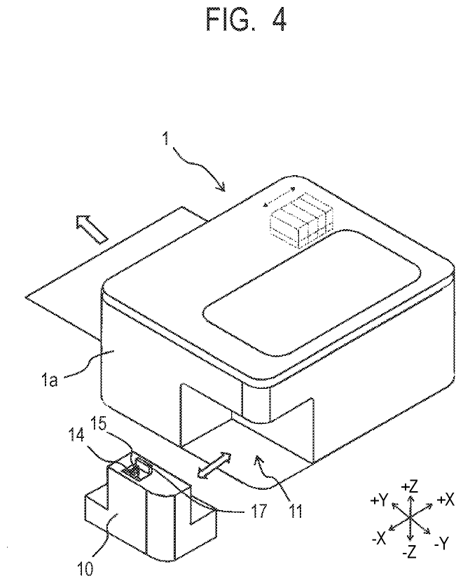

FIG. 2 is a side view schematically illustrating a maintenance unit 6 provided inside the liquid ejection apparatus 1. FIGS. 3 and 4 are diagrams illustrating an attaching and detaching operation of the waste liquid container 10 to a mounting portion 11, FIG. 3 is a partial perspective view of the mounting portion 11 as viewed from below, and FIG. 4 is a perspective view of the entire liquid ejection apparatus 1 as viewed from above. The maintenance unit 6 illustrated in FIG. 2 includes a cap 7, a waste liquid tube 8, a pump 9, and the mounting portion 11 (refer to FIG. 3) on which the waste liquid container 10 is mounted. A discharge portion 12 is provided on a top surface 11a of the mounting portion 11. The cap 7 illustrated in FIG. 2 receives the liquid (waste liquid) discharged from the liquid ejection head 3 for maintenance regardless of the recording. The pump 9 guides the waste liquid in the cap 7 to the discharge portion 12 via the waste liquid tube 8 and discharges the waste liquid from the discharge portion 12. As illustrated in FIG. 3, a waste liquid holding portion 13 is provided on the top surface 11a of the mounting portion 11 so as to surround the discharge portion 12. The waste liquid holding portion 13 is capable of holding the waste liquid in order to prevent the waste liquid discharged from the discharge portion 12 from dripping around the discharge portion 12 and contaminating the inside of a housing 1a.

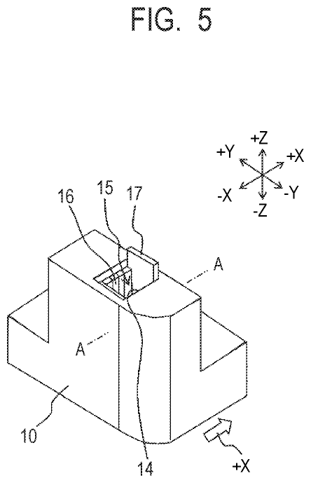

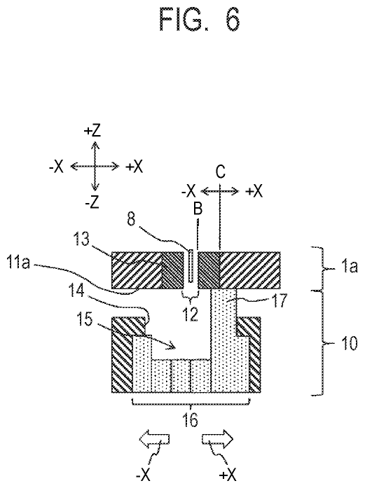

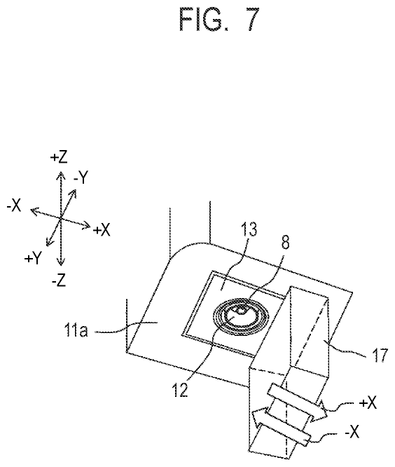

FIG. 5 is a perspective view of the waste liquid container 10. FIG. 6 is a cross-sectional view taken along the line A-A of FIG. 5, which is a partial cross-sectional view schematically illustrating a state in which the waste liquid container 10 is mounted on the mounting portion 11. FIG. 7 is a partial perspective view of a periphery of a discharge portion 12 and a waste liquid holding portion 13 in the middle of attaching and detaching operation with respect to the mounting portion 11 of the waste liquid container 10 as viewed from below. The waste liquid container 10 can store the waste liquid and is detachable from the mounting portion 11. The waste liquid container 10 includes a waste liquid introduction portion 14 that opens upward (+Z direction), a waste liquid storage chamber 15 that communicates with the waste liquid introduction portion 14, and a waste liquid absorber 16 made of a water-absorbent material such as a porous body. As illustrated in FIG. 6, the waste liquid absorber 16 of the present embodiment is formed of a plurality of blocks, and these blocks are arranged and stored in the waste liquid storage chamber 15 in a state of being arranged in the X direction, which is the attaching and detaching direction of the waste liquid container 10. A part of the waste liquid absorber 16 forms a wiping portion 17 that protrudes upward (+Z direction) from a part around the waste liquid introduction portion 14 on the upper surface of the waste liquid container 10, that is, the surface facing the discharge portion 12. The wiping portion 17 is capable of being in contact with the waste liquid holding portion 13 in the mounting portion.

From the state where the waste liquid container 10 is detached as illustrated in FIGS. 3 and 4, as illustrated in FIGS. 1 and 6, when the waste liquid container 10 is mounted on the mounting portion 11, the waste liquid introduction portion 14 of the waste liquid container 10 faces the discharge portion 12. The direction in which the waste liquid container 10 is mounted on the mounting portion 11 is the +X direction, and the direction in which the waste liquid container 10 is detached from the mounting portion 11 is the −X direction. In other words, the front side of the waste liquid container 10 to the mounting portion 11 in the mounting direction is in the +X direction, and the rear side is in the −X direction. The front side in the direction in which the waste liquid container 10 is detached from the mounting portion 11 is in the −X direction, and the rear side is in the +X direction.

With the waste liquid container 10 mounted on the mounting portion 11, the waste liquid is discharged from the liquid ejection head 3 for maintenance or the like. As described above, the waste liquid is guided to the discharge portion 12 via the cap 7 and the waste liquid tube 8, and the waste liquid is discharged from the discharge portion 12, penetrates into the inside of the waste liquid container 10 from the waste liquid introduction portion 14, and is stored and held in the waste liquid storage chamber 15. The wiping portion 17 protrudes from the upper surface of the waste liquid container 10 toward the top surface 11a where the discharge portion 12 of the mounting portion 11 is provided. The height of the wiping portion 17 protruding in the +Z direction from the upper surface of the waste liquid container 10 is the same as or slightly larger than the distance between the upper surface of the waste liquid container 10 mounted on the mounting portion 11 and the top surface 11a of the mounting portion 11. Therefore, in the attaching and detaching operation of the waste liquid container 10 with respect to the mounting portion 11, the tip end portion of the wiping portion 17 comes into contact with the discharge portion 12 and the waste liquid holding portion 13 as illustrated in FIG. 7.

With the waste liquid container 10 mounted on the mounting portion 11, the wiping portion 17 comes into contact with the top surface 11a of the mounting portion 11 at a position shifted in the +X direction, which is the back side of the mounting portion 11, that is, the front side in the mounting direction (rear side in the detaching direction), from the position facing the discharge portion 12 (refer to FIG. 6). Assuming that the end portion of the discharge portion 12 in the +X direction is a reference point B, the wiping portion 17 is located in the +X direction from the reference point B in a state where the waste liquid container 10 is mounted on the mounting portion 11. Therefore, when the waste liquid container 10 is moved in the −X direction in order to be detached from the mounting portion 11, the wiping portion 17 moves while being in contact with the waste liquid holding portion 13. The waste liquid attached to the waste liquid holding portion 13 is wiped off by the wiping portion 17 as the waste liquid container 10 is detached from the mounting portion 11. As a result, in this liquid ejection apparatus 1, even if the waste liquid container 10 is detached from the mounting portion 11 and the discharge portion 12 and the waste liquid holding portion 13 are exposed, the waste liquid of the waste liquid holding portion 13 is wiped off by the wiping portion 17. Therefore, it is possible to suppress the user's hands, clothes, and the like from being contaminated by the waste liquid attached to the waste liquid holding portion 13.

Assuming that the end portion of the waste liquid holding portion 13 in the +X direction is a reference point C (refer to FIG. 6), in a state where the waste liquid container 10 is mounted on the mounting portion 11, it is preferable that the wiping portion 17 comes into contact with a region of the waste liquid holding portion 13 including the reference point C and straddling the −X direction side and the +X direction side of the reference point C. In this configuration, in a state where the waste liquid container 10 is mounted on the mounting portion 11, the wiping portion 17 functions as a waste liquid guiding unit that guides the waste liquid attached to the waste liquid holding portion 13 into the inside of the waste liquid container 10.

As illustrated in FIG. 7, the wiping portion 17 preferably has a direction orthogonal to the direction in which the waste liquid container 10 is detached from the mounting portion 11, that is, a width in the Y direction, which is equal to or larger than the width of the waste liquid holding portion 13 in the Y direction. As a result, the entire waste liquid holding portion 13 can be wiped off by the wiping portion 17 at the same time as the attaching and detaching operation of the waste liquid container 10, and the wiping effect of the waste liquid can be enhanced. Note that, at least a part of the wiping portion 17 may be located on the rear side in the direction in which the waste liquid container 10 is detached from the mounting portion 11, and since the whole is located on the rear side in the detached direction, the effect of wiping the waste liquid can be enhanced.

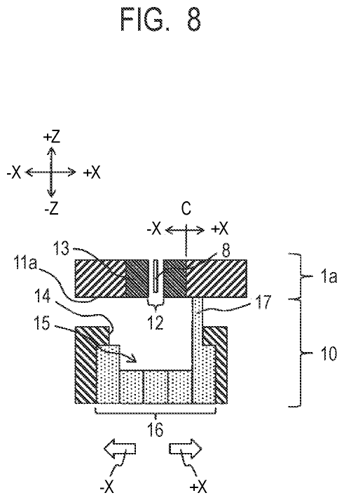

Next, a modification of the liquid ejection apparatus of the present embodiment will be described. FIG. 8 is a partial cross-sectional view illustrating a state in which the waste liquid container 10 of the modification is mounted on the mounting portion 11. As illustrated in FIG. 8, in a state where the waste liquid container 10 is mounted on the mounting portion 11, the wiping portion 17 of this modification does not face the reference point C and is located on the +X direction side of the reference point C. That is, in a state where the waste liquid container 10 is mounted on the mounting portion 11, the wiping portion 17 and the waste liquid holding portion 13 do not come into contact with each other. According to this modification, in the state where the waste liquid container 10 is mounted on the mounting portion 11, the wiping portion 17 is dried because it does not come into contact with the waste liquid attached to the waste liquid holding portion 13. The dried wiping portion 17 has a high effect of wiping the waste liquid when it comes into contact with the waste liquid holding portion 13.

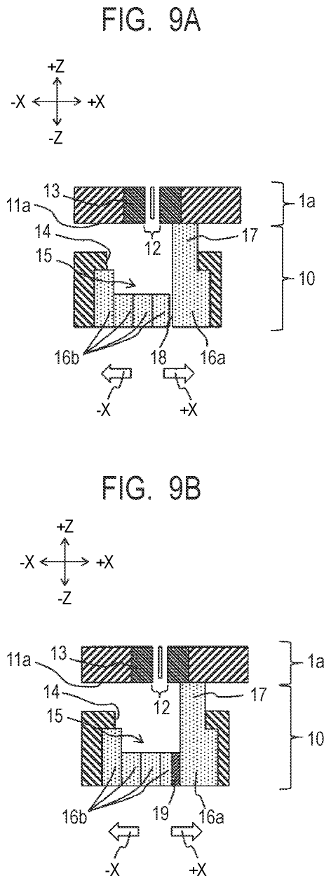

FIGS. 9A and 9B schematically illustrate a state in which the waste liquid container 10 of the liquid ejection apparatus 1 is mounted on the mounting portion 11 in another modification and still another modification of the present embodiment. In these modifications, a block 16a having the wiping portion 17 is independent of the other block 16b in the waste liquid absorber 16 formed of a plurality of blocks. In the modification illustrated in FIG. 9A, a gap 18 is provided between the block 16a having the wiping portion 17 and the other block 16b inside the waste liquid storage chamber 15. In addition, in another modification illustrated in FIG. 9B, a partition 19 is provided between the block 16a having the wiping portion 17 and the other block 16b inside the waste liquid storage chamber 15. Further, although not shown, the gap 18 and the partition 19 can be provided between the block 16a having the wiping portion 17 and the other block 16b. In these configurations, inside the waste liquid storage chamber 15, the block 16a having the wiping portion 17 does not come into direct contact with the other block 16b because both are via the gap 18 or the partition 19 or both intervene therebetween. As a result, even if the other block 16b absorbs the waste liquid in the state where the waste liquid container 10 is mounted on the mounting portion 11, it is possible to prevent the wiping portion 17 from coming into contact with the waste liquid due to capillary force or the like. Therefore, the wiping portion 17 can be kept in a dry state, and the effect of wiping the waste liquid when it comes into contact with the waste liquid holding portion 13 can be enhanced. In a case where the partition 19 is provided, the partition 19 is preferably formed of a material having no water absorption. In the configuration illustrated in FIGS. 9A and 9B, although not shown, a part of the other block 16b can protrude from the upper surface of the waste liquid container 10 in the +Z direction so as to be in contact with the waste liquid holding portion 13 so as to function as a waste liquid guiding portion. Although the block 16a having the wiping portion 17 and the other block 16b may be formed of the same material or different materials, both are preferably formed of a material having water absorption such as a porous body.

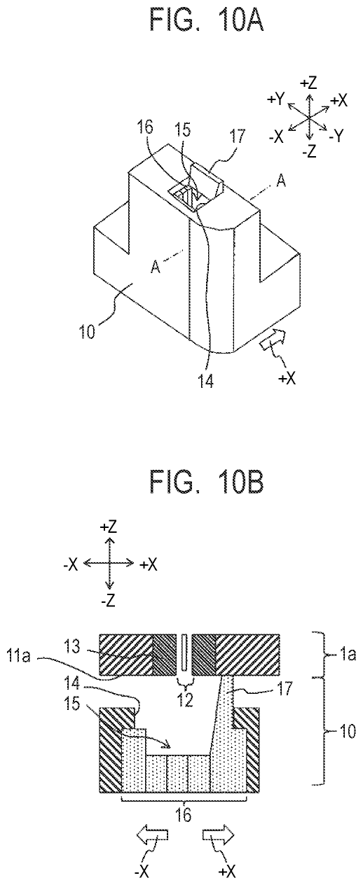

Still another modification of the liquid ejection apparatus of the present embodiment will be described. FIG. 10A is a perspective view of a waste liquid container 10 of still another modification of the first embodiment of the present invention. FIG. 10B is a cross-sectional view taken along the line A-A of FIG. 10A, which is a partial cross-sectional view schematically illustrating a state in which the waste liquid container 10 of the liquid ejection apparatus 1 is mounted on the mounting portion 11. As illustrated in FIGS. 10A and 10B, the wiping portion 17 of this modification has a tapered shape that tapers upward (+Z direction), that is, toward the tip end portion capable of coming into contact with the waste liquid holding portion 13. The area of the wiping portion 17 in contact with the top surface 11a of the mounting portion 11 is small, and the area on the waste liquid storage chamber 15 side is large. According to this configuration, the strength of the wiping portion 17 is high, and the shape change due to the wiping operation can be suppressed.

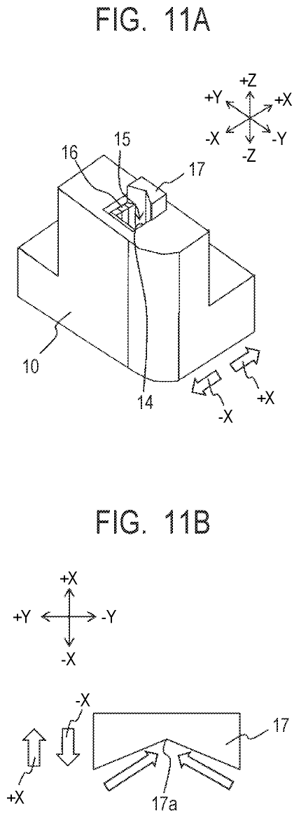

Further, FIG. 11A is a perspective view of the waste liquid container 10 of still another modification of the first embodiment of the present invention, and FIG. 11B is an enlarged plan view of the wiping portion 17. As illustrated in FIGS. 11A and 11B, the dimension of the wiping portion 17 of this modification in the X direction, which is the direction (wiping direction) in which the waste liquid container 10 is detached, is gradually decreased from both end portions toward the center of the wiping portion in the Y direction, which is orthogonal to the direction in which the waste liquid container 10 is detached. When the wiping portion 17 of this modification moves in the −X direction in the operation of detaching the waste liquid container 10, a V-shaped end face comes into contact with the waste liquid holding portion 13 to wipe the waste liquid. Therefore, the waste liquid of the waste liquid holding portion 13 is wiped off along the flow toward a V-shaped recess portion 17a of the wiping portion 17. Therefore, the flow of waste liquid from the Y direction, which is the width direction of the wiping portion 17, is suppressed, and the wiping efficiency is excellent.

The configuration in which waste liquid container 10 is detachable with respect to the mounting portion 11 is particularly effective in the liquid ejection apparatus 1 equipped with a liquid continuous supply system capable of replenishing a liquid tank 4 provided in the liquid ejection apparatus 1 from a replenishing container such as a bottle. The reason for this is that, in such a liquid ejection apparatus 1, the amount of liquid used tends to be larger than before, along with this, the amount of waste liquid discharged increases, but by making the waste liquid container 10 detachable, it is possible to discharge a large amount of waste liquid by replacing the waste liquid container 10.

### Second Embodiment

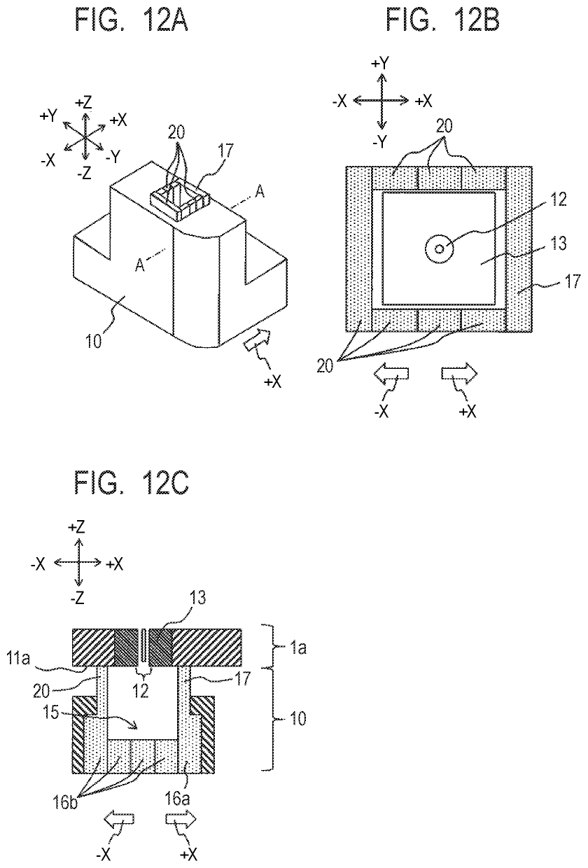

Next, a second embodiment of the liquid ejection apparatus 1 of the present invention will be described. FIG. 12A is a perspective view of the waste liquid container 10 of the present embodiment. FIG. 12B is an enlarged bottom view of the periphery of the discharge portion 12, the waste liquid holding portion 13, and the wiping portion 17 of the liquid ejection apparatus of the present embodiment as viewed from below. FIG. 12C is a sectional view taken along line A-A of FIG. 12A, and is a partial cross-sectional view which schematically illustrates the discharge portion 12, the waste liquid holding portion 13, and the waste liquid container 10 in the state in which the waste liquid container 10 is attached to the mounting portion 11. Here, the differences between the present embodiment and the first embodiment described above will be mainly described, and the same parts as those of the first embodiment will be omitted.

The waste liquid absorber 16 of the present embodiment includes the same wiping portion 17 as that of the first embodiment, and the blocks 16b other than the block 16a having the wiping portion 17 also have a protruding portion 20 protruding upward (+Z direction) from the upper surface of the waste liquid container 10. In the present embodiment, in a state where the waste liquid container 10 is mounted on the mounting portion 11, the waste liquid holding portion 13 is surrounded by the wiping portion 17 and the protruding portion 20. According to this configuration, for example, even in a case where the liquid ejection apparatus 1 is tilted or inverted, the wiping portion 17 and the protruding portion 20 can prevent the waste liquid from leaking to the outside of the waste liquid container 10. That is, it is possible to prevent the waste liquid from leaking from the discharge portion 12 and the waste liquid holding portion 13 and contaminating the outside of the waste liquid container 10 and the periphery of the apparatus. The wiping portion 17 and the protruding portion 20 have substantially the same configuration; however, the wiping portion 17 is a member for wiping the waste liquid of the waste liquid holding portion 13 in accordance with the operation of detaching the waste liquid container 10 from the mounting portion 11. On the other hand, the protruding portion 20 is a member for surrounding the waste liquid holding portion 13 together with the wiping portion 17 in a state where the waste liquid container 10 is mounted on the mounting portion 11, even though it is not necessary to wipe the waste liquid without contacting the waste liquid holding portion 13 when the waste liquid container 10 is detached from the mounting portion 11.

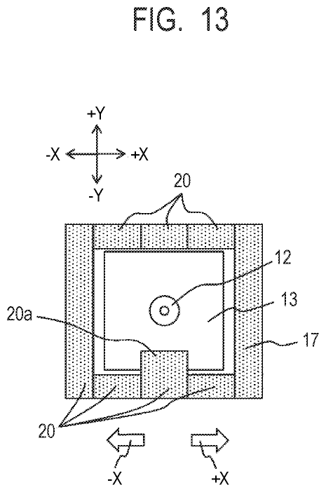

FIG. 13 is an enlarged bottom view of the periphery of the discharge portion 12, the waste liquid holding portion 13, and the wiping portion 17 of a modification of the present embodiment of the present invention as viewed from below. In this modification, as illustrated in FIG. 13, a convex portion 20a protruding in the direction toward the center of the space surrounded by the wiping portion 17 and the protruding portion 20 is formed in a part of the protruding portion 20 of the block 16b other than the block having the wiping portion 17. In a state where the waste liquid container 10 is mounted on the mounting portion 11, the convex portion 20a comes into contact with the waste liquid holding portion 13 and functions as a liquid guiding portion. As a result, the waste liquid absorber 16 is highly reliable to efficiently absorb the waste liquid discharged from the discharge portion 12 and the waste liquid attached to the waste liquid holding portion 13, and to prevent the waste liquid from leaking to the outside of the waste liquid container 10 in the four directions surrounding the discharge portion 12 and the waste liquid holding portion 13.

As described above, according to the liquid ejection apparatus 1 of the present invention, in accordance with the operation of detaching the waste liquid container 10 from the mounting portion 11, the wiping portion 17 moves in the −X direction while coming into contact with the waste liquid holding portion 13 to wipe off the waste liquid attached to the waste liquid holding portion 13. As a result, even if the waste liquid holding portion 13 is exposed, since the amount of waste liquid attached to the waste liquid holding portion 13 is small, it is possible to reduce the possibility of contaminating the user's hands and clothes. In particular, there is a large effect of suppressing the user's hands and clothes from being contaminated by the wiping portion 17 wiping the waste liquid of the waste liquid holding portion 13 during the operation of detaching the waste liquid container 10 at the timing immediately before the waste liquid holding portion 13 is exposed.

While the present invention has been described with reference to exemplary embodiments, it is to be understood that the invention is not limited to the disclosed exemplary embodiments. The scope of the following claims is to be accorded the broadest interpretation so as to thereby all such modifications and equivalent structures and functions.

This application claims the benefit of Japanese Patent Application No. 2020-004209, filed Jan. 15, 2020, which is hereby incorporated by reference herein in its entirety.

What is claimed is:

1. A liquid ejection apparatus comprising:
a liquid ejection head that ejects a liquid;
a discharge portion that discharges a waste liquid from the liquid ejection head;
a waste liquid holding portion that is provided around the discharge portion;
a waste liquid container that is capable of containing the waste liquid; and
a mounting portion on which the discharge portion and the waste liquid holding portion are provided and the waste liquid container is mounted,
wherein the waste liquid container is detachable from the mounting portion,
the waste liquid container has a wiping portion that moves while being in contact with the waste liquid holding portion in accordance with a detaching operation from the mounting portion, and
at least a part of the wiping portion is located on a rear side from the discharge portion in a direction in which the waste liquid container is detached.

2. The liquid ejection apparatus according to claim 1,
wherein the waste liquid container faces the discharge portion in a state of being mounted on the mounting portion.

3. The liquid ejection apparatus according to claim 1,
wherein in a state where the waste liquid container is mounted on the mounting portion, the wiping portion comes into contact with the waste liquid holding portion at a position on a rear side from the discharge portion in the direction in which the waste liquid container is detached.

4. The liquid ejection apparatus according to claim 3,
wherein in a state where the waste liquid container is mounted on the mounting portion, the wiping portion guides the waste liquid to the waste liquid container from the waste liquid holding portion.

5. The liquid ejection apparatus according to claim 1,
wherein in a state where the waste liquid container is mounted on the mounting portion, the wiping portion is positioned on a rear side further from an end portion of the waste liquid holding portion on a rear side in a direction in which the waste liquid container is detached and does not come into contact with the waste liquid holding portion.

6. The liquid ejection apparatus according to claim 1,
wherein in a direction orthogonal to a direction in which the waste liquid container is detached, a width of the wiping portion is equal to or larger than a width of the waste liquid holding portion.

7. The liquid ejection apparatus according to claim 1,
wherein a dimension of the wiping portion in a direction in which the waste liquid container is detached is gradually decreased from both end portions toward the center of the wiping portion in a direction orthogonal to the direction in which the waste liquid container is detached.

8. The liquid ejection apparatus according to claim 1,
wherein the wiping portion has a tapered shape that tapers toward a tip end portion capable of coming into contact with the waste liquid holding portion.

9. The liquid ejection apparatus according to claim 1,
wherein the waste liquid container includes a waste liquid storage chamber, a waste liquid introduction portion for introducing the waste liquid into the waste liquid storage chamber, and a waste liquid absorber formed of a plurality of blocks arranged inside the waste liquid storage chamber, and
a part of the waste liquid absorber protrudes from an upper surface of the waste liquid container to form the wiping portion.

10. The liquid ejection apparatus according to claim 9,
wherein a part of at least one of the plurality of blocks forming the waste liquid absorber protrudes from the upper surface of the waste liquid container to form the wiping portion.

11. The liquid ejection apparatus according to claim 10,
wherein in the inside of the waste liquid storage chamber, a gap is provided between a block having the wiping portion and the other block, among the plurality of blocks forming the waste liquid absorber.

12. The liquid ejection apparatus according to claim 10,
wherein in the inside of the waste liquid storage chamber, a partition is provided between a block having the wiping portion and another block, among the plurality of blocks forming the waste liquid absorber.

13. The liquid ejection apparatus according to claim 10,
wherein a protruding portion protruding from the upper surface of the waste liquid container is provided in a part of another blocks other than the block having the wiping portion, among the plurality of blocks forming the waste liquid absorber, and
in a state where the waste liquid container is mounted on the mounting portion, the wiping portion and the protruding portion surround the discharge portion and the waste liquid holding portion.

14. A method for detaching a waste liquid container with respect to a mounting portion of a liquid ejection apparatus including a liquid ejection head that ejects a liquid, a discharge portion that discharges a waste liquid from the liquid ejection head, a waste liquid holding portion that is provided around the discharge portion, the waste liquid container that is capable of containing the waste liquid, and the mounting portion on which the discharge portion and the waste liquid holding portion are provided and the waste liquid container is mounted,
wherein the waste liquid container is detachable from the mounting portion, and has a wiping portion capable of being in contact with the waste liquid holding portion in the mounting portion,
at least a part of the wiping portion is located on a rear side from the discharge portion in a direction in which the waste liquid container is detached, and
in accordance with an operation of detaching the waste liquid container from the mounting portion, the wiping portion moves while coming into contact with the waste liquid holding portion to wipe off the waste liquid attached to the waste liquid holding portion.
